(19) United States
(12) Patent Application Publication
(10) Pub. No.: US 2021/0148746 A1
(43) Pub. Date: May 20, 2021

(54) DEVICE AND METHOD FOR DETERMINING THE PHASE INTERFACE LEVEL IN A TANK

(71) Applicant: SAIPEM S.A., Montigny le Bretonneux (FR)

(72) Inventor: Raymond HALLOT, Voisins le Bretonneux (FR)

(73) Assignee: SaiPem S.A., Montigny le Bretonneux (FR)

(21) Appl. No.: 17/043,153

(22) PCT Filed: Mar. 13, 2019
(86) PCT No.: PCT/FR2019/050547

§ 371 Date: Sep. 29, 2020

(30) Foreign Application Priority Data
Apr. 11, 2018 (FR) 1853151

(51) Int. Cl. G01F 23/16; G01L 11/02; G01L 15/00; G01L 9/00

(52) U.S. Cl. CPC G01F 23/161; G01F 23/164; G01L 9/0076; G01L 15/00; G01L 11/025

(57) ABSTRACT

A method for determining the phase interface level of a multiphase system, includes a tank intended to receive a multiphase system including at least two fluids having distinct phases, and a tube vertically immersed inside the tank. The tube is intended to be filled with a fluid at equal pressure with the fluid contained in the tank at the level of a headspace of the tank. The tube has a plurality of differential pressure sensors per membrane which are spaced apart vertically from each other along the tube to measure the pressure difference between the fluids contained and stratified in height in the tank and the fluid contained in the tube.

### BACKGROUND OF THE INVENTION

The present invention relates to the general field of tanks, in particular of multiphase gravity separators used in the field of the production of hydrocarbons, for example petroleum and gas.

It relates more particularly to a device making it possible to determine the phase interface level in a gravity separation tank, for example a subsea gravity separation tank, used to separate the aqueous, gas and oil phases of fluids coming from a hydrocarbon production well.

The extraction of the subsea hydrocarbon production wells generates a multiphase mixture (water, petroleum, gas and sand) that must be treated to recover only what will be used, namely the petroleum and the gas. Generally, this multiphase mixture is brought on board an FPSO (Floating Production Storage Offloading) to be treated therein with a view to separating the petroleum per se, from the water, the gas and any solid components. The petroleum, once separated, is then stored on board, the gas is washed then sent to the gas turbines for the production of electricity and heat necessary on board, then the surplus is re-injected into the tank of the oil field so as to be re-pressurized. The water, after having been released from the suspended solid particles, is either discharged into the sea after extraction of the possible oil particles, or also re-injected into the tank. Finally, the extracted solid particles, which represent only minimal quantities, are partly retreated and recycled on site to be discharged into the sea or in special basins, and partly sent ashore for treatment and storage and/or re-injected into the subsoil by the well.

One of the known methods for separating the water and the oil contained in the multiphase mixture extracted from the production well consists in using a very large volume tank, generally of cylindrical shape: the petroleum enters at one end of the tank and progresses therealong to allow the different phases of the mixture to be naturally separated by gravity and reach the other end of the tank. This type of separator hereinafter referred to as “gravity separator” is generally used for crude petroleum also containing gas, the gas being then recovered in the upper part of the tank, the water and the sand in the lower part, and the petroleum (oil) in the middle part.

In addition, it can often be advantageous to carry out the separation of the multiphase mixture extracted from the production well directly on the seabed to have to bring to the surface only the hydrocarbon phases and not the aqueous phase, which can be re-injected into another well on the seabed.

For this purpose, it is known to resort to subsea gravity separators installed on the seabed. Thus, there is known from Document WO 2011/161343 a subsea gravity separator comprising in particular a plurality of cylindrical ducts positioned horizontally and parallel to each other, these ducts forming tanks in which the multiphase mixture extracted from the production well circulates. During this circulation, the different phases of the mixture are naturally separated by gravity: the water lies at the bottom of the tank, the oil is above the water and the gas is above the oil. At the outlet of the ducts, the water is typically recovered to be treated before being re-injected into the well by water injection pumps, while the oil and gas phases are conveyed on the surface to the FPSO.

When the different phases of the multiphase mixture present in the tank of the gravity separator are separated, it is important to accurately measure the phase interface level in the tank, that is to say the level in the tank between two superimposed phases (water/oil interface and oil/gas interface). The result of this measurement indeed makes it possible to ensure perfect regulation of the flow rate of the water injection pumps, which improves the operation of the separator.

The measurement of the phase interface level in the tank of a gravity separator is generally carried out by gamma-ray level sensors as described in particular in the publication EP 2,329,234. However, this type of sensor implements radiation sources that are harmful to the underwater environment as well as in terms of hygiene and safety for the staff. In addition, the detectors associated with these sensors are complex components with low reliability according to the operators, which makes the measurement results inaccurate.

The publication EP 1,184,647 is also known, which describes a method for combined inductive and capacitive measurement of an interface level, as well as the publication WO 2009/063194 which discloses a system for measuring an interface level by ultrasound.

### OBJECT AND SUMMARY OF THE INVENTION

The main aim of the present invention is therefore to propose a device for determining the phase interface level which does not have the aforementioned drawbacks.

According to the invention, this aim is achieved thanks to a device for determining the phase interface level of a multiphase system, comprising a tank intended to receive a multiphase system comprising at least two fluids having distinct phases, and a tube vertically immersed inside the tank, said tube being intended to be filled with a fluid at equal pressure with the fluid contained in the tank at the level of a gas headspace, the tube comprising a plurality of differential pressure sensors per membrane which are spaced apart vertically from each other along the tube to measure the pressure difference between the fluids contained and stratified in height in the tank and the fluid contained in the tube.

The device according to the invention is remarkable in particular in that it uses differential pressure sensors per membrane which are spaced apart in strings of sensors over the entire height of the tank to determine the phase interface levels of the multiphase system. The invention starts from the observation that the different phases of the multiphase system contained in the tank have different densities, these differences in densities generating a pressure gradient over the height of the tank. Thus, through knowledge of the pressure gradient variations over the entire height of the tank and of a linear regression calculation, it is possible to accurately determine the phase interface level within the tank. Indeed, the phase interfaces are localized at the heights for which the density of the system changes, that is to say at the heights for which the pressure gradient varies.

It will be noted that the variation in the absolute pressure as a function of the rise in the measurement points (on the order of a few millibars) is very small compared to the pressure value in the tank (on the order of several tens of bars) and its variability (from 1 bar to several hundred bar), the inventors have cleverly resolved this contradiction by filling the tube with a fluid at equal pressure with the headspace of the tank contained in the tank. In this way, the differential pressure sensors measure only the pressure deviations in the liquid phases compared to the pressure of the gas phase.

It will also be noted that the device according to the invention is neutral with respect to the staff during the installation and to the underwater environment (it does not emit any harmful radiation). Finally, it will be noted that the device according to the invention has a comparatively advantageous cost because the components in underwater environment are reduced and the complex constituents can be displaced on the surface.

Each differential pressure sensor advantageously comprises a corrosion-resistant sealed membrane which is mounted in an orifice of the tube and which is fixed to a Bragg grating optical fiber strain sensor, the strain of said membrane being intended to measure a differential of pressure between, on the one hand, the multiphase mixture contained in the tank and, on the other hand, the fluid contained in the tube.

It will be noted that the recourse to Bragg grating optical fiber strain sensors for the acquisition of the pressure gradient obtained by the strain of the membranes is particularly advantageous: these optical fiber sensors are reliable with respect to the underwater environment and insensitive to the water ingress and to the electromagnetic disturbances. In addition, the data processing electronics can be placed on the surface in a controllable environment accessible for maintenance.

The membranes of the differential pressure sensors preferably extend over the entire height of the tank.

Likewise, the orifices of the tube in which the membranes of the differential pressure sensors are mounted are advantageously positioned on several lateral faces of the tube, each lateral face of the tube being able to provided with the same number of differential pressure sensors being able to be spaced apart at the same pitch in height from a different initial height from a lower end of the tube in order to increase the spatial resolution of the measurement.

As for the Bragg grating optical fiber strain sensors, they are preferably fixed to the center of the membrane of each differential pressure sensor. The Bragg grating optical fiber strain sensors can be advantageously distributed in several independent strain sensor gratings in order to obtain redundancy of the measurement chain.

Preferably, the tube comprises a central cavity intended to be filled with a fluid at equal pressure with the fluid contained in the tank at the level of the headspace of said tank, said central cavity being closed at a lower end and obstructed at an upper end by an expansion bellows. This expansion bellows makes it possible to accommodate the possible variations in the volume of equal pressure fluid while transmitting the external pressure of the gas headspace thereto.

The object of the invention is also a method for determining the phase interface level in a tank receiving a multiphase system by means of a device as defined above, the device comprising:

for each differential pressure sensor Cⱼ, with 1<j≤n, the calculation of the slope of the differential pressure measurement line associated with the two differential pressure sensors Cⱼ₋₁, Cⱼ;
for each differential pressure sensor Cⱼ, with 2<j<n, the calculation of the variance associated with each set of sensors C₂ to Cⱼ of the slope of the differential pressure measurement line associated with the two differential pressure sensors Cⱼ₋₁, Cⱼ;
for each differential pressure sensor Cⱼ, with 2<j<n, the calculation of the variance associated with each set of sensors Cⱼ₊₁ to Cₙ of the slope of the differential pressure measurement line associated with the two differential pressure sensors Cⱼ₋₁, Cⱼ;
for each differential pressure sensor Cⱼ, with 2<j<n, the calculation of the sum of the two previously calculated variances;
the localization of at least a local minimum of the sum of the two previously calculated variances in order to identify the sensor Cⱼ corresponding to a phase interface level; and
the intersection of the linear regression line of the measurements from the sensors Cⱼ to C₁ with the linear regression line of the measurements from the sensors Cⱼ₊₁ to Cₙ in order to identify the height of the phase interface level.

In case of localization of two local minima which identify two sensors Cⱼ and Cₖ, the intersection of the linear regression line of the measurements from the differential pressure sensors Cⱼ to C₁ with the linear regression line of the measurements from the differential pressure sensors Cⱼ₊₁ to Cₖ accurately identifies a first phase interface level height, and the intersection of the linear regression line of the measurements from the differential pressure sensors Cₖ₊₁ to Cₙ with the linear regression line of the measurements from the differential pressure sensors Cⱼ₊₁ to Cₖ accurately identifies a second phase interface level height different from the first height.

The calculation of the slopes of linear regression lines is preferably carried out by the method of least squares. The tube of the device can be filled with a liquid having a low freezing point and a high boiling point, for example glycol.

### BRIEF DESCRIPTION OF THE DRAWINGS

Other characteristics and advantages of the present invention will emerge from the description given below, with reference to the appended drawings which illustrate an exemplary embodiment thereof without any limitation. In the figures:

FIG. 1 is a sectional view of a cylindrical multiphase gravity separation tank equipped with a device for determining the phase interface level according to the invention;

FIG. 2 is a perspective view of the tube of the device of FIG. 1;

FIG. 3 is a longitudinal sectional view of FIG. 2;

FIG. 4 is a sectional view along IV-IV of the tube of FIG. 3; and

FIGS. 5A and 5B illustrate two examples of curves of pressure differential as a function of the height in a gravity separation tank obtained by the implementation of the method for determining the phase interface level according to the invention.

### DETAILED DESCRIPTION OF THE INVENTION

The invention relates to a device for determining the phase interface level in a multiphase system tank, in particular in a multiphase gravity separation tank, for example a subsea multiphase gravity separation tank, that is to say a device making it possible to measure inside a tank the levels between the different phases separated into several superimposed strata of an initially multiphase mixture (in particular water, gas and oil).

By “multiphase system” is meant here a mixture of at least two fluids having different phases, namely in particular a mixture of fluids in different phases (i.e. liquid phase, aqueous phase and gas phase), or a mixture of at least two liquids that are immiscible with each other.

Typically, a subsea multiphase gravity separator comprises in particular several cylindrical-shaped ducts which are aligned horizontally and parallel to each other. These ducts form tanks in which the multiphase mixture (for example a mixture extracted from a hydrocarbon production well) is injected at one of the ends. The ducts are long enough to allow the different phases of the mixture to be separated by gravity inside the ducts. At the end opposite to their injection, the ducts are connected to one or several pump(s) which will suck the oil and gas phases of the mixture to send them on the surface (to an FPSO), while the aqueous phase is sucked by another pump to be returned to the production well.

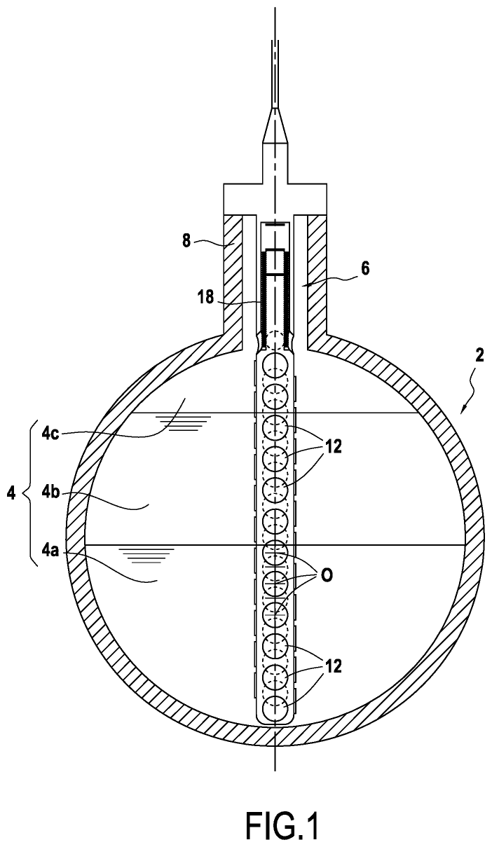

FIG. 1 represents, in cross section, a duct forming a tank 2 of such a subsea multiphase gravity separator. Of course, the present invention is not limited to the subsea gravity separators but also applies to the terrestrial gravity separators and in general to any type of tank, whether in the open air or not.

The tank 2 has a circular-shaped cross section. It is filled with a multiphase mixture 4 whose phases, under the effect of gravity, are separated into a fluid in a liquid state (water layer 4a at the bottom of the tank), a fluid in an oil state (oil layer 4b above the water layer), and a fluid in a gas state (gas layer 4c above the oil layer).

A tube 6 of longitudinal axis X-X is mounted vertically inside the tank 2 by being immersed in the multiphase mixture 4. More specifically, the tube 6 passes right through the tank and is fixed in its upper part on a vertical tap 8 of the tank.

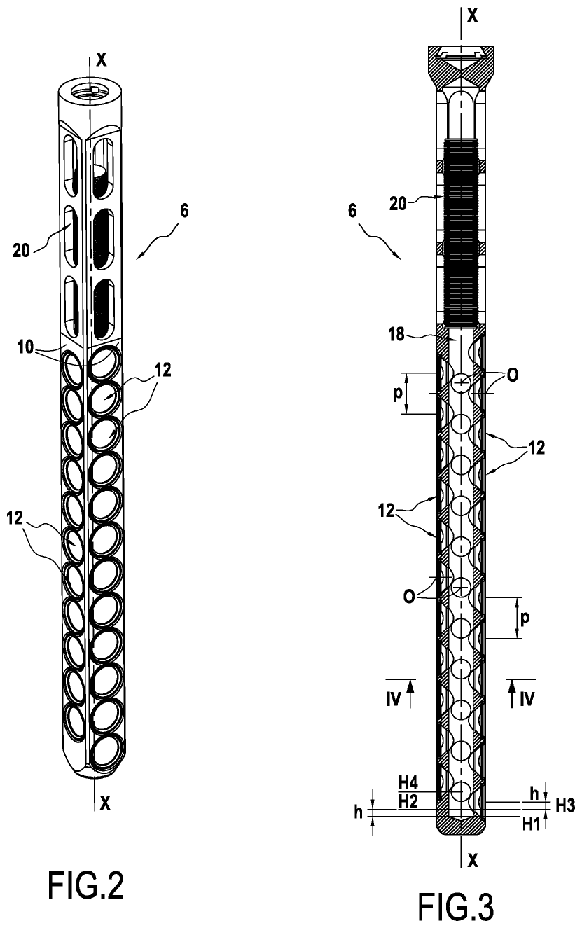

As represented in FIGS. 2 and 3, the tube 6 may have, in its part immersed in the tank, a substantially square-shaped cross section with four lateral faces 10. More generally, this cross section of the tube may have a polygonal (for example hexagonal) shape. Moreover, in the case of a very high tube, it can have only one face equipped with differential pressure sensors.

Each of these lateral faces 10 preferably comprises the same number n of differential pressure sensors 12 (in the example illustrated in FIGS. 1 to 3, the number n of differential pressure sensors is equal to 11 on one face and to 12 on a second face).

The differential pressure sensors 12 are distributed over the entire height of the tank. For each lateral face 10 of the tube, the differential pressure sensors are spaced apart at the same pitch p in height from an initial height, respectively H1, H2, H3, H4, different from a lower end of the tube.

FIG. 3 represents the respective initial heights H1 to H4 for all of the lateral faces 10 of the tube. It will be understood that these initial heights are offset longitudinally relative to each other by the same distance h.

Preferably, the distance h between the respective initial heights H1 to Hf (in the case of a tube 6 with a cross section in the form of a polygon with f lateral faces) is equal to p/(f−1), p being the pitch spacing between two adjacent differential pressure sensors. Thus, in the example of a tube 6 having four lateral faces, the distance h between the respective initial heights H1 to H4 is preferably equal to p/3.

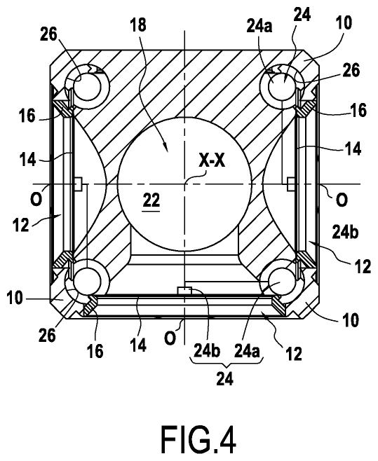

Furthermore, as more specifically represented in FIG. 4, each differential pressure sensor 12 is composed of a sealed membrane 14 (or tympanum) made of corrosion-resistant material (for example alloy or glass) which is sealingly mounted in an orifice 16 made in the lateral faces 10 of the tube and a Bragg grating optical fiber strain sensor 24 which is fixed to the membrane 14.

The membrane 14 of these differential pressure sensors thus separates the interior of the tube from the interior of the tank 2. The membrane is thus subjected to a pressure differential between, on the one hand, the multiphase mixture 4 contained in the tank and, on the other hand, the fluid 22 contained in the tube.

It will be noted that the membranes 14 form, for each lateral face 10 of the tube, a string of point sensors which cover the entire height of the tank (the membranes are distributed over the entire height of the tank).

It will also be noted that the orifices 16 (for example of circular shape) made in the lateral faces 10 of the tube and in which the membranes 14 of the differential pressure sensors are mounted can be aligned, for each lateral face of the tube, on an axis parallel to the longitudinal axis X-X of the tube.

In addition, the interior of the tube 6 comprises a central cavity 18 which is closed at the lower end of the tube, obstructed in its upper part by a metal expansion bellows 20 and which receives a fluid 22 having a low freezing point and a high boiling point (typically glycol or hydraulic oils).

When the temperature varies, the volume of the fluid 22 contained in the central cavity 18 of the tube will vary and this variation is taken up by the expansion bellows 20. Thanks to the flexibility of the expansion bellows, any internal volume variation will not result in pressure variation inside the central cavity 18 of the tube.

Furthermore, the great flexibility of the expansion bellows makes it possible to affirm that the pressure inside the tube is equal to the external pressure, so that the expansion bellows transmits the external pressure to the fluid 22 contained inside the tube. We are talking about equal pressurization of the interior of the tube with the headspace of the fluid 4c.

In practice, the tube 6 is generally prepared in the following way: application of a vacuum, then filling with the fluid 22, in this case glycol or hydraulic oils for application to a hydrocarbon separator and closing with a sealed plug.

The expansion bellows 20 is more specifically positioned at the upper part of the tube which passes through the vertical shoulder 8 of the tank.

Still according to the invention, the differential pressure sensors 12 comprise, for the acquisition of the measurement of the pressure differential, Bragg grating optical fiber strain sensors 24 fixed to the membranes 14 (the strain of the membranes under the effect of the pressure differential results in elongation or contraction of the Bragg grating optical fiber).

For this purpose, as represented in FIG. 4, the tube 6 comprises four lateral holes 26 which extend longitudinally over the entire height of the tube. The optical fibers of the Bragg grating optical fiber strain sensors 24 have a measurement point 24a fixed by bonding to the center of the membranes 14 and a part 24b which progresses between two adjacent measurement points via the lateral holes 26.

Different configurations are possible for the Bragg grating optical fiber strain sensors 24. It is possible to envisage a chain of 11 or 12 optical fiber strain sensors for each lateral face 10 of the tube (each chain showing a forward and possibly a return direction in one of the lateral holes 26 of the tube), or two chains of two times 11 or 12 optical fiber strain sensors (with the forward direction through two lateral holes and return direction through the two other lateral holes), or a chain of four times 11 or 12 optical fiber strain sensors for all four lateral faces.

Preferably, in order to obtain measurement redundancy by the acquisition of two independent measurement chains, it is still possible to position two chains of Bragg grating optical fiber strain sensors side by side on the same membrane.

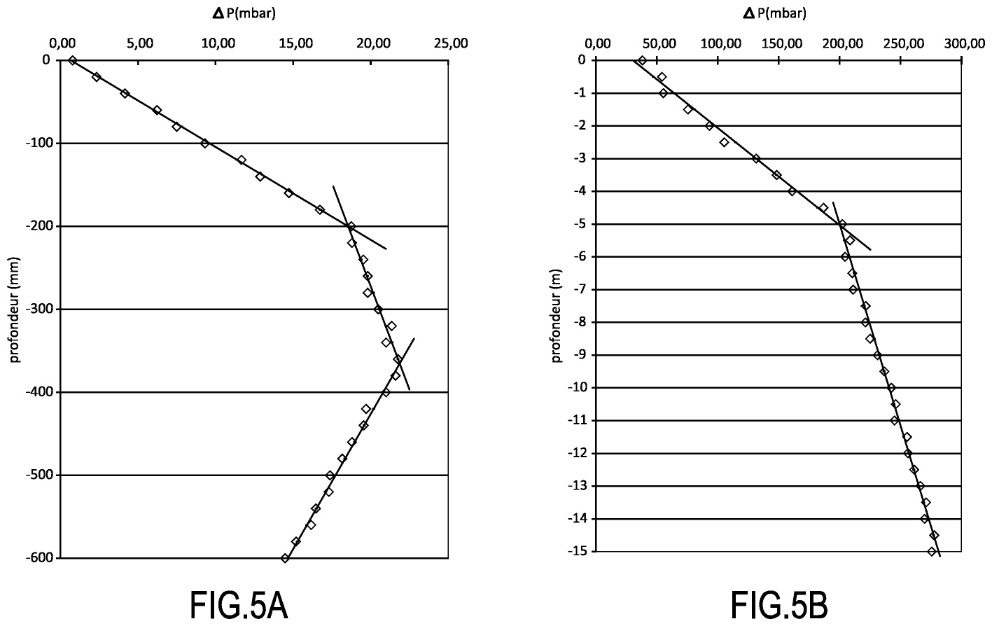

An example of a non-limiting algorithm for determining the phase interface level by the device according to the invention as described above is described below in relation to FIGS. 5A and 5B.

For each set of two consecutive differential pressure sensors Cⱼ, Cⱼ₊₁, software means calculate:

for each differential pressure sensor Cⱼ, with 1<j≤n, the slope of the differential pressure measurement line associated with the two differential pressure sensors Cⱼ₋₁, Cⱼ;
for each differential pressure sensor Cⱼ, with 2<j<n, the variance associated with each set of sensors C₂ to Cⱼ of the slope of the differential pressure measurement line associated with the two differential pressure sensors Cⱼ₋₁, Cⱼ;
for each differential pressure sensor Cⱼ, with 2<j<n, the variance associated with each set of sensors Cⱼ₊₁ to Cₙ of the slope of the differential pressure measurement line associated with the two differential pressure sensors Cⱼ₋₁, Cⱼ; and
for each differential pressure sensor Cⱼ, with 2<j<n, the sum of the two previously calculated variances.

From these calculations, the software means localize at least a local minimum of the sum of the two previously calculated variances, this local minimum being identified at a sensor Cₖ corresponding to a phase interface level.

The software means then construct the linear regression line of the measurements from the sensors Cₖ to C₁ on the one hand, and the linear regression line of the measurements from the sensors Cₖ₊₁ to Cₙ on the other hand. The intersection of these two linear regression lines accurately identifies the height of the phase interface level.

When there are two local minima which identify two sensors Cₗ and Cₖ, the intersection of the linear regression line of the measurements from the sensors Cₗ to C₁ with the linear regression line of the measurements from the sensors Cₗ₊₁ to Cₖ accurately identifies a first phase interface level height, and the intersection of the linear regression line of the measurements from the sensors Cₖ₊₁ to Cₙ with the linear regression line of the measurements from the sensors Cₗ₊₁ to Ck accurately identifies a second phase interface level height.

The number of extrema sought corresponds to the number of phase interfaces sought (a single extremum for a fluid stratified in two phases, and two extrema for a fluid stratified in three phases).

A first example of data thus calculated is proposed in Table 1 below and illustrated by the curve of FIG. 5A. This example applies to the case of a fluid present in a gravity separation tank which is in a stratification of three different phases, namely a gas phase, an aqueous phase and a liquid phase. The measurements were carried out using 31 differential pressure sensors spaced apart from each other between a tank depth equal to 0 mm (for the uppermost sensor) up to a tank depth equal to −600 mm (for the lowest sensor).

FIG. 5A represents for this first example the pressure differential curve ΔP (in mbar) measured by the pressure differential sensors as a function of the depth (in mm) in the gravity separation tank.

TABLE 1

| | | | slopes of | | | |
|---|---|---|---|---|---|---|
| | | | the lines | | | |
| | | | connecting 2 | variance | variance | |
| | ΔP | depth | consecutive | 1 of the | 2 of the | sum of the |
| Cⱼ | (mbar) | (mm) | sensors | slopes | slopes | variances |
| 1 | 0.78 | 0 | | | | |
| 2 | 2.33 | −20 | −0.08 | | | |
| 3 | 4.16 | −40 | −0.09 | 0.00005 | 0.00289 | 0.00294 |
| 4 | 6.23 | −60 | −0.10 | 0.00011 | 0.00272 | 0.00284 |
| 5 | 7.50 | −80 | −0.06 | 0.00023 | 0.00274 | 0.00296 |
| 6 | 9.33 | −100 | −0.09 | 0.00019 | 0.00259 | 0.00278 |
| 7 | 11.67 | −120 | −0.12 | 0.00030 | 0.00220 | 0.00250 |
| 8 | 12.89 | −140 | −0.06 | 0.00037 | 0.00216 | 0.00253 |
| 9 | 14.73 | −160 | −0.09 | 0.00032 | 0.00189 | 0.00221 |
| 10 | 16.73 | −180 | −0.10 | 0.00030 | 0.00148 | 0.00178 |
| 11 | 18.76 | −200 | −0.10 | 0.00029 | 0.00095 | 0.00124 |
| 12 | 18.80 | −220 | 0.00 | 0.00091 | 0.00099 | 0.00189 |
| 13 | 19.54 | −240 | −0.04 | 0.00098 | 0.00091 | 0.00189 |
| 14 | 19.82 | −260 | −0.01 | 0.00120 | 0.00091 | 0.00211 |
| 15 | 19.80 | −280 | 0.00 | 0.00148 | 0.00095 | 0.00243 |
| 16 | 20.49 | −300 | −0.03 | 0.00145 | 0.00083 | 0.00228 |
| 17 | 21.36 | −320 | −0.04 | 0.00139 | 0.00058 | 0.00197 |
| 18 | 21.00 | −340 | 0.02 | 0.00168 | 0.00062 | 0.00230 |
| 19 | 21.76 | −360 | −0.04 | 0.00161 | 0.00032 | 0.00193 |
| 20 | 21.60 | −380 | 0.01 | 0.00175 | 0.00030 | 0.00204 |
| 21 | 21.00 | −400 | 0.03 | 0.00200 | 0.00032 | 0.00233 |
| 22 | 19.71 | −420 | 0.06 | 0.00250 | 0.00024 | 0.00274 |
| 23 | 19.55 | −440 | 0.01 | 0.00251 | 0.00020 | 0.00271 |
| 24 | 18.80 | −460 | 0.04 | 0.00267 | 0.00023 | 0.00290 |
| 25 | 18.18 | −480 | 0.03 | 0.00276 | 0.00026 | 0.00302 |
| 26 | 17.38 | −500 | 0.04 | 0.00287 | 0.00029 | 0.00316 |
| 27 | 17.30 | −520 | 0.00 | 0.00281 | 0.00017 | 0.00298 |
| 28 | 16.46 | −540 | 0.04 | 0.00290 | 0.00021 | 0.00311 |
| 29 | 16.17 | −560 | 0.01 | 0.00286 | 0.00005 | 0.00291 |
| 30 | 15.19 | −580 | 0.05 | 0.00296 | 0.00000 | 0.00296 |
| 31 | 14.49 | −600 | 0.04 | | | |

In this first example, two extrema are identified for the sum of the variances, namely for the “sensor 11” located at a depth of −200 mm and for the “sensor 19” located at a depth of −360 mm.

It is therefore deduced that the interface between the gas and aqueous phases of the fluid contained in the gravity separation tank is located at the sensor 11 at a depth more accurately calculated by linear regression of −208.56 mm in the tank and that the interface between the aqueous and liquid phases of the fluid is located at the sensor 9 at a depth more accurately calculated by linear regression of −365.40 mm in the tank.

A second example of data is proposed in Table 2 below. This example applies to the case of a fluid present in a gravity separation tank which is in a stratification of two different phases, namely a gas phase and a liquid phase.

As in the previous example, the measurements were carried out using 31 differential pressure sensors spaced apart from each other between a tank depth equal to 0 m (for the uppermost sensor) up to a tank depth equal to at −15 m (for the lowest sensor).

FIG. 5B represents for this first example the pressure differential curve ΔP (in mbar) measured by the pressure differential sensors as a function of the depth (in m) in the tank.

TABLE 2

| | | | slopes of | | | |
|---|---|---|---|---|---|---|
| | | | the lines | | | |
| | | | connecting 2 | variance | variance | |
| | ΔP | depth | consecutive | 1 of the | 2 of the | sum of the |
| Cⱼ | (mbar) | (m) | sensors | slopes | slopes | variances |
| 1 | 38.32 | 0 | | | | |
| 2 | 54.35 | −0.5 | −32.04 | | | |
| 3 | 55.45 | −1 | −2.21 | 14.92 | 15.82 | 30.73 |
| 4 | 75.56 | −1.5 | −40.22 | 16.34 | 15.37 | 31.71 |
| 5 | 93.17 | −2 | −35.22 | 14.84 | 15.13 | 29.97 |
| 6 | 105.41 | −2.5 | −24.47 | 13.33 | 15.28 | 28.61 |
| 7 | 131.62 | −3 | −52.41 | 15.46 | 13.33 | 28.79 |
| 8 | 148.53 | −3.5 | −33.83 | 14.34 | 12.80 | 27.15 |
| 9 | 161.15 | −4 | −25.24 | 13.58 | 12.72 | 26.30 |
| 10 | 186.96 | −4.5 | −51.62 | 14.39 | 9.21 | 23.59 |
| 11 | 202.45 | −5 | −30.98 | 13.66 | 7.89 | 21.56 |
| 12 | 208.69 | −5.5 | −12.47 | 14.28 | 8.01 | 22.29 |
| 13 | 204.52 | −6 | 8.33 | 17.46 | 7.34 | 24.80 |
| 14 | 210.49 | −6.5 | −11.93 | 17.30 | 7.48 | 24.78 |
| 15 | 211.18 | −7 | −1.39 | 17.88 | 7.54 | 25.42 |
| 16 | 221.46 | −7.5 | −20.55 | 17.30 | 7.04 | 24.34 |
| 17 | 221.22 | −8 | 0.47 | 17.80 | 6.97 | 24.77 |
| 18 | 225.10 | −8.5 | −7.76 | 17.63 | 7.23 | 24.86 |
| 19 | 231.11 | −9 | −12.02 | 17.29 | 7.42 | 24.70 |
| 20 | 236.76 | −9.5 | −11.30 | 16.98 | 7.65 | 24.63 |
| 21 | 242.53 | −10 | −11.54 | 16.67 | 7.88 | 24.56 |
| 22 | 246.08 | −10.5 | −7.10 | 16.52 | 8.31 | 24.82 |
| 23 | 244.98 | −11 | 2.21 | 16.77 | 8.18 | 24.95 |
| 24 | 255.35 | −11.5 | −20.74 | 16.41 | 6.96 | 23.37 |
| 25 | 256.07 | −12 | −1.45 | 16.44 | 7.27 | 23.71 |
| 26 | 261.22 | −12.5 | −10.28 | 16.18 | 7.74 | 23.92 |
| 27 | 266.38 | −13 | −10.33 | 15.93 | 8.27 | 24.20 |
| 28 | 271.03 | −13.5 | −9.29 | 15.71 | 9.02 | 24.73 |
| 29 | 269.81 | −14 | 2.44 | 15.85 | 9.98 | 25.84 |
| 30 | 277.69 | −14.5 | −5.76 | 15.58 | 0.00 | 15.58 |
| 31 | 275.59 | −15 | 4.20 | | | |

In this second example, a minimum is identified for the sum of the variances, namely for the “sensor 11” located at a depth of −5 m.

It is therefore deduced that the interface between the gas and liquid phases of the fluid contained in the gravity separation tank is located at the sensor 11 at a depth more accurately calculated by linear regression of −5.04 m in the tank.

Of course, it is possible to consider other algorithms than the one described previously to determine the phase interface level from the strain measurements collected from the Bragg grating optical fiber strain sensors.

1.-10. (canceled)

11. A device for determining the phase interface level of a multiphase system, comprising:
a tank intended to receive a multiphase system comprising at least two fluids having distinct phases;
a tube vertically immersed inside the tank, said tube being intended to be filled with a fluid at equal pressure with the fluid contained in the tank at the level of a headspace of said tank, the tube comprising a plurality of differential pressure sensors per membrane which are spaced apart vertically from each other along the tube to measure the pressure difference between the fluids contained and stratified in height in the tank and the fluid contained in the tube
each differential pressure sensor comprising a corrosion-resistant sealed membrane which is mounted in an orifice of the tube and which is fixed to a Bragg grating optical fiber strain sensor, the strain of said membrane being intended to measure a differential of pressure between, on the one hand, the multiphase mixture contained in the tank and, on the other hand, the fluid contained in the tube; and
the orifices of the tube in which the membranes of the differential pressure sensors are mounted being positioned on several lateral faces of the tube, each lateral face of the tube being provided with the same number of differential pressure sensors spaced apart at the same pitch in height from a different initial height from a lower end of the tube in order to increase the spatial resolution of the measurement.

12. The device according to claim 11, wherein the membranes of the differential pressure sensors extend over the entire height of the tank.

13. The device according to claim 11, wherein the Bragg grating optical fiber strain sensors are fixed to the center of the membrane of each differential pressure sensor.

14. The device according to claim 11, wherein the Bragg grating optical fiber strain sensors are distributed in several independent strain sensor gratings in order to obtain redundancy of the measurement chain.

15. The device according to claim 11, wherein the tube comprises a central cavity intended to be filled with a fluid at equal pressure with the fluid contained in the tank at the level of a headspace of said tank, said central cavity being closed at a lower end and obstructed at an upper end by an expansion bellows.

16. The device according to claim 11, wherein the Bragg grating optical fiber sensors progress longitudinally inside the tube.

17. A method for determining the phase interface level in a tank receiving a multiphase system by means of a device according to claim 11, comprising:
for each differential pressure sensor Cj, with 1<j≤n, the calculation of the slope of the differential pressure measurement line associated with the two differential pressure sensors Cj−1, Cj;
for each differential pressure sensor Cj, with 2<j<n, the calculation of the variance associated with each set of sensors C2 to Cj of the slope of the differential pressure measurement line associated with the two differential pressure sensors Cj−1, Cj;
for each differential pressure sensor Cj, with 2<j<n, the calculation of the variance associated with each set of sensors Cj+1 to Cn of the slope of the differential pressure measurement line associated with the two differential pressure sensors Cj−1, Cj;
for each differential pressure sensor Cj, with 2<j<n, the calculation of the sum of the two previously calculated variances;
the localization of at least a local minimum of the sum of the two previously calculated variances in order to identify the sensor Cj corresponding to a phase interface level; and
the intersection of the linear regression line of the measurements from the sensors Cj to C1 with the linear regression line of the measurements from the sensors Cj+1 to Cn in order to identify the height of the phase interface level.

18. The method according to claim 17, wherein, in case of localization of two local minima which identify two sensors Cj and Ck, the intersection of the linear regression line of the measurements from the differential pressure sensors Cj to C1 with the linear regression line of the measurements from the differential pressure sensors Cj+1 to Ck accurately identifies a first phase interface level height, and the intersection of the linear regression line of the measurements from the differential pressure sensors Ck+1 to Cn with the linear regression line of the measurements from the differential pressure sensors Cj+1 to Ck accurately identifies a second phase interface level height different from the first height.

19. The method according to claim 17, wherein the calculation of the slopes of linear regression lines is carried out by the method of least squares.

20. The method according to claim 17, wherein the tube of the device is filled with a liquid having a low freezing point and a high boiling point.
